(19) United States
(12) Patent Application Publication
(10) Pub. No.: US 2025/0356190 A1
(43) Pub. Date: Nov. 20, 2025

(54) FINETUNING ONE OR MORE NEURAL NETWORKS

(71) Applicant: QUALCOMM Incorporated, San Diego, CA (US)

(72) Inventors: Wonguk CHO, Suwon (KR); Matthias REISSER, Mountain View, CA (US); Debasmit DAS, San Diego, CA (US); Seokeon CHOI, Yongin-si (KR); Sungrack YUN, Seongnam (KR); Fatih Murat PORIKLI, San Diego, CA (US)

(21) Appl. No.: 18/663,903

(22) Filed: May 14, 2024

(51) Int. Cl. G06N 3/082

(52) U.S. Cl. CPC G06N 3/082

(57) ABSTRACT

Systems and techniques are described herein for training and using a machine-learning model (e.g., a neural network). For example, a computing device can: process, using a first trained neural network, data specific to a user to obtain intermediate activation data representing the data, the first trained neural network comprising a plurality of neural network layers; process, using a second trained neural network, the intermediate activation data to generate an output representing the data, the second trained neural network comprising a subset of neural network layers from the plurality of neural network layers of the first trained neural network; determine a loss based on the output; and update parameters of the second trained neural network based on the loss.

### TECHNICAL FIELD

The present disclosure generally relates to machine learning systems, such as neural networks. For example, aspects of the present disclosure relate to systems and techniques for finetuning a full neural network (e.g., a diffusion neural network model having a U-Net architecture) based on finetuning a smaller neural network (e.g., a hollowed neural network) that is a modified version of the full network (e.g., based on one or more neural network layers being removed from the full network).

### BACKGROUND

Machine-learning models (e.g., deep neural networks, such as large language models (LLMs), convolutional neural networks, transformers, diffusion models, etc.) are trained to provide an inference or prediction based on input data. For example, deep neural networks (e.g., LLMs, etc.) can be pre-trained on large datasets to generalize to a wide range of tasks. Applications of deep neural networks include optical flow estimation, text summarization, text generation, sentiment analysis, content creation such as performing generative operations, chatbots, virtual assistants, and conversational artificial intelligence, named entity recognition, speech recognition and synthesis, image annotation, text-to-speech synthesis, spell correction, machine translation, recommendation systems, fraud detection, accomplishing tasks and code generation. ′

### SUMMARY

Systems and techniques are described herein for finetuning one or more neural networks. According to some aspects, an apparatus for finetuning one or more neural networks is provided. The apparatus includes a memory and a processor (e.g., a graphics processing unit (GPU), a neural processing unit (NPU), a neural signal processor (NSP), a digital signal processor (DSP), or other processor) and configured to: process, using a first trained neural network, data specific to a user to obtain intermediate activation data representing the data, the first trained neural network including a plurality of neural network layers; process, using a second trained neural network, the intermediate activation data to generate an output representing the data, the second trained neural network including a subset of neural network layers from the plurality of neural network layers of the first trained neural network; determine a loss based on the output; and update parameters of the second trained neural network based on the loss.

In some aspects, a method for finetuning one or more neural networks is provided. The method includes: processing, using a first trained neural network, data specific to a user to obtain intermediate activation data representing the data, the first trained neural network including a plurality of neural network layers; processing, using a second trained neural network, the intermediate activation data to generate an output representing the data, the second trained neural network including a subset of neural network layers from the plurality of neural network layers of the first trained neural network; determining a loss based on the output; and updating parameters of the second trained neural network based on the loss.

In some aspects, a computer-readable storage medium is provided storing instructions which, when executed by at least one processor coupled, cause the at least one processor to: process, using a first trained neural network, data specific to a user to obtain intermediate activation data representing the data, the first trained neural network including a plurality of neural network layers; process, using a second trained neural network, the intermediate activation data to generate an output representing the data, the second trained neural network including a subset of neural network layers from the plurality of neural network layers of the first trained neural network; determine a loss based on the output; and update parameters of the second trained neural network based on the loss.

In some aspects, an apparatus for finetuning one or more neural networks is provided. The apparatus includes: means for processing, using a first trained neural network, data specific to a user to obtain intermediate activation data representing the data, the first trained neural network including a plurality of neural network layers; means for processing, using a second trained neural network, the intermediate activation data to generate an output representing the data, the second trained neural network including a subset of neural network layers from the plurality of neural network layers of the first trained neural network; means for determining a loss based on the output; and means for updating parameters of the second trained neural network based on the loss.

In some aspects, one or more of apparatuses described herein include a mobile device (e.g., a mobile telephone or so-called “smart phone” or other mobile device), a wireless communication device, a vehicle or a computing device, system, or component of the vehicle, an extended reality (XR) device (e.g., a virtual reality (VR) device, an augmented reality (AR) device, or a mixed reality (MR) device), a wearable device, a personal computer, a laptop computer, a server computer, a camera, or other device. In some aspects, the processor of the apparatus includes a GPU, NPU, NSP, DSP, or other processor). In some aspects, the apparatus includes a camera or multiple cameras for capturing media data (e.g., one or more images and/or video). In some aspects, the apparatus includes an image sensor that captures the media data. In some aspects, the apparatus includes a user input device for receiving user input (e.g., an indication of an item of media content, a text input associated with the item of media content, a text prompt to generate an image comprising a particular object, etc.). In some aspects, the apparatus includes a display for displaying the image, one or more notifications (e.g., associated with processing of the image), and/or other displayable data.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 is a diagram illustrating the concept of on-device personalization for a machine-learning model, in accordance with some aspects of this disclosure;

FIG. 2 is a diagram illustrating a comparison of conventional finetuning of a neural network and side-tuning with a hollowed neural network, in accordance with some aspects of this disclosure;

FIG. 3 is a diagram illustrating how different sets of layers can be removed to generate a hollowed neural network, in accordance with some aspects of this disclosure;

FIG. 4 is a diagram illustrating various steps to generating a hollowed neural network, in accordance with some aspects of this disclosure;

FIG. 5 is a diagram illustrating an approach to reducing a memory cost when training a neural network, in accordance with some aspects of this disclosure;

FIG. 6 is a diagram illustrating various results of memory reduction, in accordance with some aspects of this disclosure;

FIG. 7 is a diagram illustrating the use of a hyper network when finetuning a neural network, in accordance with some aspects of this disclosure;

FIG. 8 is a diagram illustrating results of experiments with varying numbers of finetuning steps, in accordance with some aspects of this disclosure;

FIG. 9 is a diagram illustrating how to merge personalized knowledge from a hollowed neural network into a full neural network, in accordance with some aspects of this disclosure;

FIG. 10 illustrates an example process for side-tuning a hollowed neural network, according to some aspects of this disclosure;

FIG. 11 is a block diagram illustrating an example of a deep learning network, in accordance with some aspects of this disclosure;

FIG. 12 includes two sets of images that show the forward diffusion process (which is fixed) and the reverse diffusion process (which is learned) of a diffusion model;

FIG. 13 is a diagram illustrating how diffusion data is distributed from initial data to noise using a diffusion model in the forward diffusion direction, in accordance with some aspects of the present disclosure;

FIG. 14 is a diagram illustrating a U-Net architecture for a diffusion model, in accordance with some aspects of the present disclosure; and

FIG. 15 is a diagram illustrating an example system architecture for implementing certain aspects described herein, in accordance with some aspects of this disclosure.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

Machine learning systems (e.g., deep neural network systems or models, such as large language models (LLMs), large vision models (LVMs), convolutional neural networks (CNNs), recurrent neural networks (RNNs), transformers, diffusion models, etc.) can be used to perform a variety of tasks such as, for example and without limitation, optical flow prediction, generative modeling such as text-to-image generation and text-to-video generation, computer code generation, text generation, speech recognition, natural language processing tasks, detection and/or recognition (e.g., scene or object detection and/or recognition, face detection and/or recognition, speech recognition, etc.), depth estimation, pose estimation, image reconstruction, classification, three-dimensional (3D) modeling, dense regression tasks, data compression and/or decompression, and image processing, among other tasks. Moreover, machine-learning models can be versatile and can achieve high quality results in a variety of tasks.

Generative machine-learning models (e.g., generative neural networks) can be used to generate synthesized outputs (e.g., images with synthesized objects, backgrounds, etc.). An example of a generative machine-learning model is a diffusion neural network model. In some cases, generative machine-learning models can be used for large language model (LLMs) or large vision models (LVMs). For example, a text-to-image diffusion model can generate an image based on a text input (e.g., a text prompt). Effectively personalizing and customizing generative machine-learning models (e.g., including diffusion models) can become important as such models become more widely used. For example, subject-driven generation can include finetuning pre-trained diffusion models with images of user-specific subjects to generate one or more output images of the subjects based on text prompts. Using such a technique, a user can cause the diffusion model to generate personalized images including specific subjects (e.g., family, friends, pets, or other objects specific to the user) with desired appearances, backgrounds, styles, etc. Such personalization allows creative applications, including art renditions, property modifications, accessorizing, among others.

Implementing subject-driven generation using a generative machine-learning model on-device (e.g., on a user device, such as a mobile device, extended reality (XR) device, a vehicle system, etc.) can provide significantly enhanced benefits to users, such as in terms of efficiency and privacy. For example, on-device deployment of the generative machine-learning model can eliminate the need for the user device to be connected to one or more network servers (e.g., cloud servers). Such on-device deployment can allow a user to use the of the generative machine-learning model to efficiently generate personalized images anywhere without any additional cost and without the need to sacrifice privacy, as personal data and information of the user remains on-device.

Generative machine-learning models can require a large amount of processing and memory resources. For example, memory input/output (I/O) operations can be a critical bottleneck in on-device learning/training of generative machine-learning models. To address such complexity Polsinelli Ref. No. 094922-798192 of generative machine-learning model, techniques may be performed to minimize the number of parameters (e.g., weights, activations, biases, etc.) of the model that are updated or the number of training steps required for finetuning of the model parameters. However, such techniques do not effectively address the memory demands associated with the model parameters (e.g., weights and intermediate activations), which can pose a significant constraint for on-device learning with limited computational resources.

Systems, apparatuses, methods (also referred to as processes), and computer-readable media (collectively referred to herein as “systems and techniques”) are described herein for finetuning a full neural network (e.g., a diffusion neural network model having a U-Net architecture) based on finetuning a smaller neural network (referred to herein as a hollowed neural network). The full neural network is pre-trained to include tuned parameters (e.g., weights, activations, biases, etc.). The finetuning can be performed to further adapt or tune the parameters of the full neural network and/or the hollowed neural network. Finetuning the hollowed neural network can reduce the amount of memory used during training or finetuning (e.g., enabling on-device personalization for machine-learning models).

The hollowed neural network is a modified version of the full network. For example, the hollowed neural network includes a subset of neural network layers from a plurality of neural network layers included in the full network. The hollowed neural network can be generated by removing one or more neural network layers from the plurality of neural network layers of the full network. The systems and techniques can apply the training and/or finetuning to any type of machine-learning model that is trained to perform any type of task. In some cases, the one or more neural network layers that are removed from the full network can be based on a specific task, such as an image generation task (e.g., generating an image based on a text input or prompt using a text-to-image diffusion model) or other task.

According to some aspects, the systems and techniques can perform a two-stage finetuning process for personalizing the hollowed neural network and/or the full neural network with limited computational resources. For example, as noted previously, the hollowed neural network can be generated or built by removing certain neural network layers from the full neural network during the finetuning process. For example, the layers that are removed can include non-essential layers for a given task, such as a low-rank adaptation (LoRa) task. The layers may be used during inference of the full neural network. A first stage of the two-stage finetuning process can include performing a forward pass of the full neural network to generate intermediate activation data (e.g., a backward pass of the full neural network is not performed during the first stage). For example, during the forward pass, a processor (e.g., a graphics processing unit (GPU), a neural processing unit (NPU), a neural signal processor (NSP), a digital signal processor (DSP), or other processor) can process data specific to a user using the trained full neural network to obtain intermediate activation data representing the data. A second stage of the two-stage finetuning process can include finetuning of parameters (e.g., weights, activations, biases, etc.) of the hollowed neural network based on the generated intermediate activation data from the first stage, without loading the full neural network into the processor at the same time as the hollowed neural network. The two-stage finetuning process can avoid loading of both the full neural network and the hollowed neural network on the processor (e.g., the GPU, the NPU, the NSP, the DSP, or other processor) at the same time during the finetuning process.

The systems and techniques described herein provide various benefits over existing solutions. For example, directly finetuning the full neural network requires a large amount of memory and computation, as described previously. A solution that reduces some layers and/or parameters of the full neural network and finetunes the full neural network does not provide quality results, as the well-trained, generalized information of the full neural network is lost. The systems and techniques address such as issue and provide quality results for personalized finetuning by maintaining the full neural network to generate the intermediate activation data and finetuning the hollowed neural network based on user-specific data to provide the personalization.

Various aspects of the present disclosure will be described with respect to the figures.

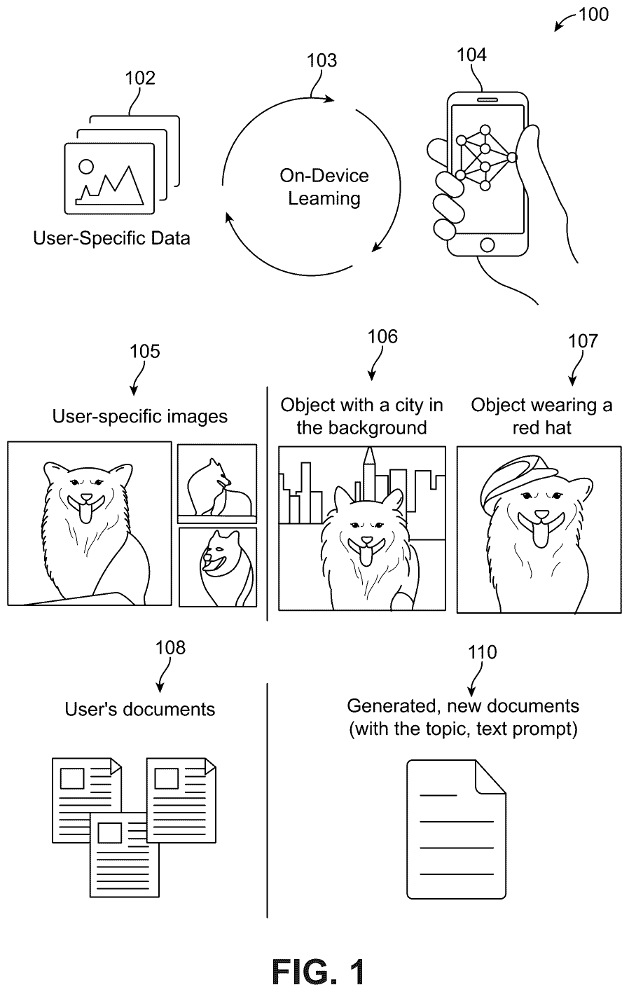

FIG. 1 is a diagram illustrating on-device personalization for a machine-learning model 100, in accordance with some aspects of this disclosure. In some cases, the on-device personalization can include using low-rank adaptation (LoRA) for a training or finetuning of a generative machine-learning model, such as an LLM or LVM. For instance, to personalize a text-to-image diffusion model, a system can finetune LoRA parameters of the diffusion model with user-specific data 102 (e.g., data specific to a particular user). The user-specific data 102 can include user-specific images 105 (e.g., an image of a person, an animal, etc.), user-specific documents 108 (e.g., writing samples personal to the user), user-specific videos (e.g., a video capturing editing or framing characteristics for the user), and so forth.

Performing training or finetuning using LoRA can address difficulties associated with finetuning of generative machine-learning models (e.g., diffusion models, LLMs, LVMs, etc.), For instance, generative machine-learning models with large numbers of parameters (e.g., billions of parameters), such as Generative Pre-trained Transformer (GPT-3) are prohibitively complex when finetuning or adapting parameters of the models for particular tasks or domains. Using LoRA, tuned parameters of the pre-trained generative model (e.g., weights) are frozen and trainable layers (e.g., rank-decomposition matrices) can be added in each transformer block. Freezing parameters of the model includes maintaining the values of the parameters after training, in which case the parameters are no longer updated in subsequent training or finetuning iterations. Such training or finetuning using LoRA can reduce the number of trainable parameters (e.g., weights) and can reduce the complexity of processor (e.g., GPU, NPU, NSP, DSP, etc.) and memory requirements. For example, gradients do not need to be computed for many of the parameters (e.g., weights). By focusing on the transformer attention blocks of generative machine-learning models, finetuning quality with LoRA is similar to finetuning of a full model, while being much faster and requiring less compute resources.

In some examples, the machine-learning model can generate new images from text prompts from the user, while preserving the style and/or identity from images included in the user-specific data 102. For instance, user-specific images 105 and a text prompt of “dog with a city in the background” can be processed by an LVM to generate a first image 106 of the user's dog with a city in the background. In another example, user-specific images 105 and a text prompt of “dog wearing a red hat” can be processed by the LVM to generate a second image 107 showing the user's dog wearing a red hat.

In some examples, the machine-learning model can generate output documents from user-specific input documents. For instance, the user-specific documents 108 may include journals, books, or articles written by the user. The user-specific documents 108 can be used to personalize an LLM (e.g., through finetuning) to the specific user. An output document 110 can be generated by the LLM based on finetuning of the LLM. The output document 110 can include or have characteristics of the writing patterns of the user learned from the user-specific documents 108.

On-device learning 103 (also referred to as on-device training) can include or apply to a generative machine-learning model (e.g., a diffusion mode, an LVM, an LLM, etc.) implemented or deployed on a user device 104. The user device can include a mobile device, extended reality (XR) device (e.g., a virtual reality (VR) device, an augmented reality (AR) device, or a mixed reality (MR) device), a wearable device, a vehicle system, or other device). The on-device learning 103 can be used to tune or adapt the machine-learning model to provide on-device personalization based on the user-specific data 102. As noted previously, such on-device learning 103 can personalize the user experience and can protect privacy of the user (e.g., as personal information remains on the device and not on a network server). Due to limited computational resources of the user device 104, on-device personalization is not feasible with existing machine-learning methods.

Various techniques can be used to provide efficient personalization of generative machine-learning models, such as diffusion machine-learning models. For example, during finetuning of a diffusion machine-learning model, backpropagation can include many steps (e.g., five thousand steps for text embeddings or one thousand steps for a full diffusion model). In some cases, a number of parameters or a number of training steps can be reduced. However, reducing the number of parameters and/or training steps may not be sufficient for on-device learning (e.g., finetuning). For example, reducing the number of parameters and/or training steps may not effectively address the memory demands associated with the model parameters (e.g., weights and intermediate activations), which can pose a significant constraint for on-device learning for devices (e.g., user devices, such as mobile devices, XR devices, etc.) with limited computational resources. Zero-shot personalization is another technique that can be performed to reduce model complexity, where the machine-learning model performs inference only (e.g., zero training steps are performed). However, zero-shot personalization does not address or adapt to possible failure cases.

As noted previously, systems and techniques are described herein for finetuning a full neural network based on finetuning a smaller neural network, resulting in adapted or further tuned parameters of the full neural network and/or the hollowed neural network. In some examples, the full network can include a diffusion machine-learning model (e.g., a diffusion neural network model) having a U-Net architecture. The smaller neural network is referred to herein as a hollowed neural network. The full neural network is pre-trained to include tuned parameters (e.g., weights, activations, biases, etc.).

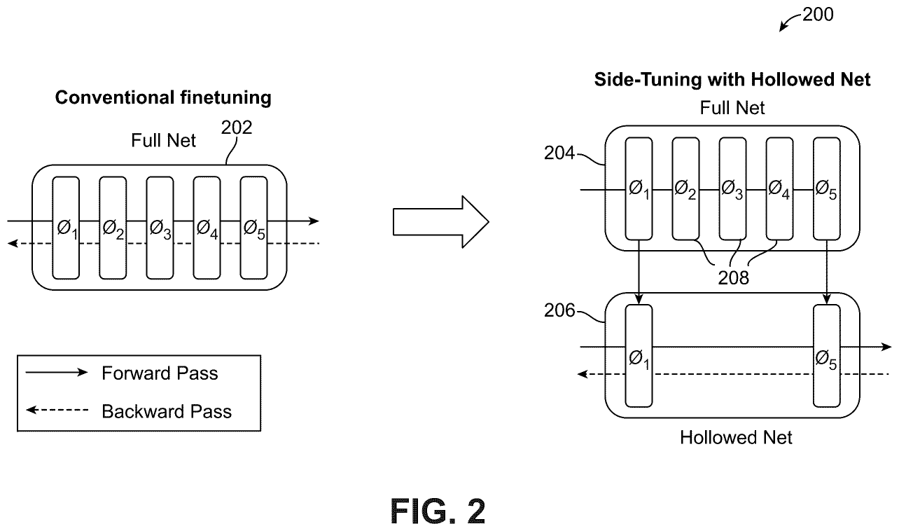

FIG. 2 is a diagram 200 illustrating conventional finetuning of a full neural network 202 and side-tuning with a hollowed neural network 206, in accordance with some aspects of this disclosure. The conventional finetuning includes performing a forward pass of the full neural network 202 (e.g., to process training data using the full neural network 202) and performing a backward pass to update parameters (e.g., weights, etc.) of the full neural network 202. The backward pass may include calculating gradients to minimize a training loss. In the conventional finetuning, all intermediate activations are calculated, layer by layer, and all of the parameter data is saved. During the backward pass, the full neural network 202 updates the parameters across all the layers during backpropagation. As a result, the conventional finetuning approach is memory intensive.

The systems and techniques described herein can perform the side-tuning using the hollowed neural network 206. For example, the systems and techniques can finetune a hollowed neural network 206 based on activation data generated during a forward pass of a full neural network 204. According to some aspects, parameters from the finetuned hollowed neural network 206 can then be transferred to the full neural network 204. The hollowed neural network 206 generated or built by removing one or more of the neural network layers (e.g., middle deep layers 208, shown in FIG. 2 as layers ϕ 2-ϕ 4) of the full neural network 204. The middle deep layers 208 can be removed based on the layers 208 not being needed or essential for a particular task, such as a personalizing task (e.g., described with respect to FIG. 1). The personalizing can be achieved by finetuning the hollowed neural network 206 using data specific to a user (referred to as user-specific data, such as user-specific data 102 of FIG. 1).

As part of the side-tuning, during a forward pass, the full neural network 204 processes the user-specific data using various layers of the full neural network 204. Based on processing the user-specific data, the full neural network 204 generates intermediate activation data (also referred to as intermediate activations or features) representing the user-specific data. The information contained in the middle deep layers 208 can be important, and thus may not be deleted. The neural network layer ϕ 1 and the neural network layer ϕ 5 of the full neural network 204, and the associated parameters (e.g., weights, activations, biases, etc.), can be included in the hollowed neural network 206. The other layers from the full neural network 204 can be omitted from the hollowed neural network 206. During a forward pass through the hollowed neural network 206, the hollowed neural network 206 can process the intermediate activations output from the forward pass of the full neural network 204 to generate an output (e.g., an output image, document, or video, such as the image 106, the image 107, the output document 110, etc.). A backward pass can then be performed through the hollowed neural network 206. For example, the backward pass can include determining a loss (e.g., a training loss, such as an L1 loss, an L2 loss, a cross-entropy (CE) loss, and/or other type of loss) based on the output and performing backpropagation by updating parameters of the hollowed neural network 206 based on the loss. In some cases, the backward pass may include calculating gradients to minimize the loss. For example, based on the backward pass, the parameters of the neural network layer ϕ 1 and the neural network ϕ 5 of the hollowed neural network 206 are updated, resulting in training of the training of the hollowed neural network 206 using much less memory in comparison to the conventional finetuning approach.

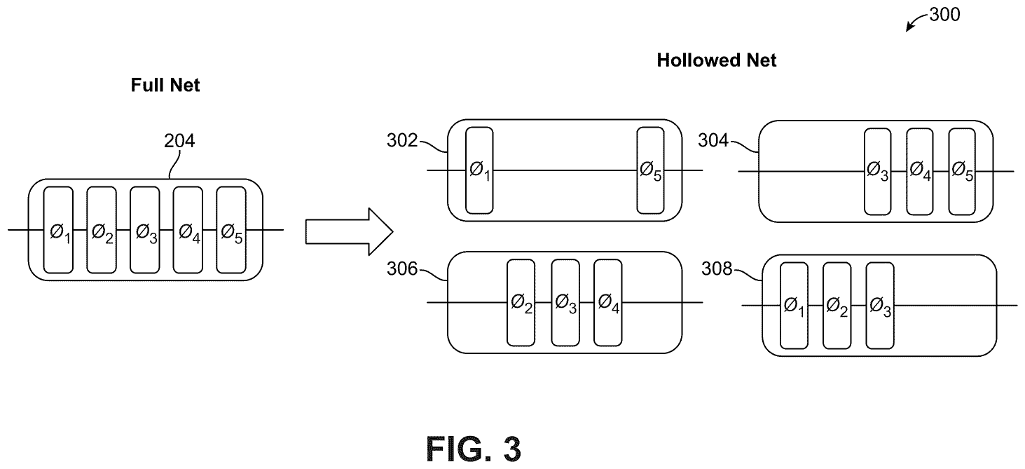

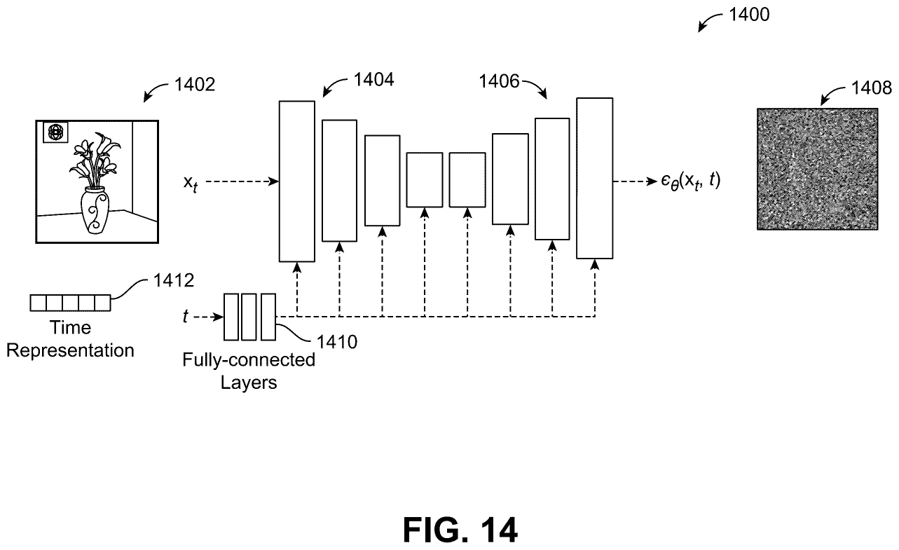

FIG. 3 is a diagram 300 illustrating how different sets of layers can be removed from a full neural network (e.g., the full neural network 204 of FIG. 2) to generate a hollowed neural network (e.g., the hollowed neural network 206 of FIG. 2), in accordance with some aspects of this disclosure. The full neural network 204 can be any neural network architecture, such as a diffusion neural network having a U-Net architecture (e.g., the U-Net architecture 1400 of FIG. 14), a neural network having one or more transformers, a convolutional neural network (CNN), and so forth.

By way of example, the full neural network 204 is shown to include five neural network layers (shown as neural network layers ϕ 1 through ϕ 5). The hollowed neural network can be generated or built by removing one or more layers from the full neural network 204 so that the hollowed neural network includes a subset of the neural network layers that are included in the full neural network 204. The neural network layers or sets of layers that are chosen for removal from the full neural network 204 can be determined based on a given task. For instance, the neural network layers that are removed can be layers that are determined to have less impact or are not as necessary in the finetuning process related to the particular task. In some aspects, such as when the neural network is a U-Net, the removal of layers may be performed in a symmetrical manner such as in the first hollow net 302. In other types of neural networks, the removal may not need to be symmetrical.

According to some examples, if the full or hollowed neural network is used for a task of personalizing images of objects (e.g., animals or people), then neural network layers ϕ 2, ϕ 3, and ϕ 4 may be removed to generate a hollowed neural network 302 that includes only the first neural network layer ϕ 1 and the fifth neural network layer ϕ 5. In some examples, the hollowed neural network 304 may be finetuned to perform a task of processing or personalizing documents based on personalized user documents. In such examples, the first layer ϕ 1 and the second layer ϕ 2 are omitted from the hollowed neural network 304 so that the hollowed neural network 304 includes the neural network layers ϕ 3, ϕ 4, and ϕ 5. Another example of a task can be to process music written by a user, in which case a hollowed neural network 306 can be generated that includes the neural network layers ϕ 2, ϕ 3, and ϕ 4, with the first neural layer ϕ 1 and the fifth neural layer ϕ 5 omitted from the hollowed neural network 306. In another example, a task may include generation of a video (e.g., based on a user-specific video provided by the user that the user directed, wrote, casted with actors, edited, or chose the music). In such an example, a hollowed neural network 308 can include the first neural network layer ϕ 1, the second neural network layer ϕ 2, and the third neural network layer ϕ 3, with the fourth neural network layer ϕ 4 and the fifth neural network layer ϕ 5 omitted from the hollowed neural network 308.

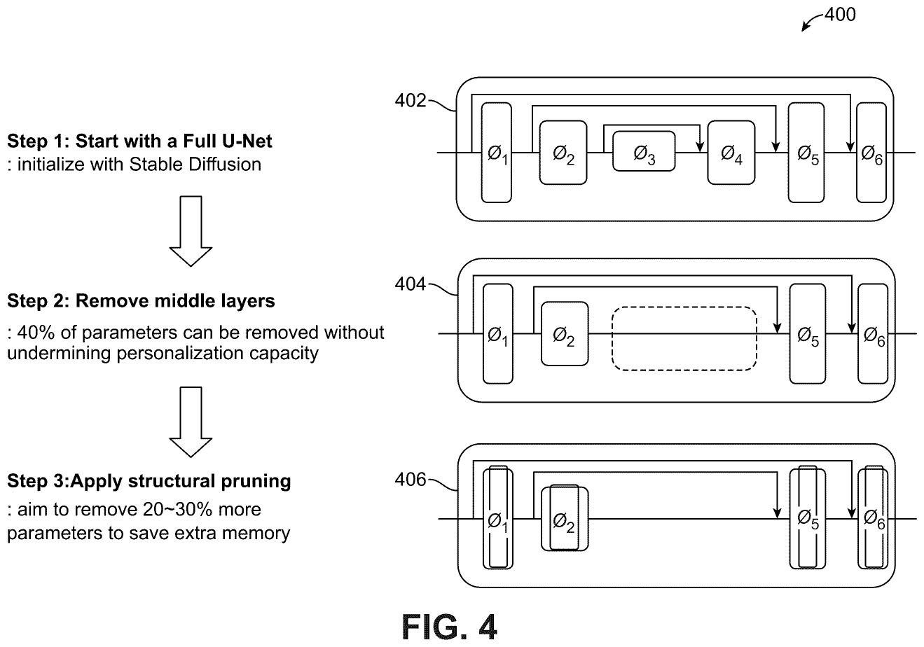

FIG. 4 is a diagram illustrating various steps for generating a hollowed neural network 400, in accordance with some aspects of this disclosure. A first U-Net 402 with six neural network layers ϕ 1 through ϕ 6 is shown by way of example, but other neural network architectures could be used. The U-Net 204 can be a diffusion neural network having a U-Net architecture, such as the U-Net architecture 1400 shown in FIG. 14. As shown, the first U-Net 402 can be initialized with pretrained weights (e.g., associated with a stable diffusion model). Particular neural network layers (e.g., middle layers) can be removed from the first U-Net 402 to generate a second U-Net 404.

For example, the third neural network layer ϕ 3 and the fourth neural network layer ϕ 4 can be removed from the U-Net 402, resulting in the second U-Net 404 having the first neural network layer ϕ 1, the second neural network layer ϕ 2, the fifth neural network layer ϕ 5, and the sixth neural network layer ϕ 6. In some cases, 40% of the parameters can be removed from the first U-Net 402 without undermining the personalization capacity of the first U-Net 402. Depending on the task and the model type, different percentages of parameters can be removed while maintaining the ability to personalize the neural network with quality results.

In some aspects, additional parameters can be pruned from the second U-Net 404. For example, structural pruning can be applied to remove additional parameters from the first neural network layer ϕ 1, the second neural network layer ϕ 2, the fifth neural network layer ϕ 5, and the sixth neural network layer ϕ 6 of the second U-Net 404. In some cases, the pruning can remove additional parameters (e.g., 20-30% more parameters) within the neural network layers of the second U-Net 404, which can save additional memory. Whether pruning is applied can depend on the neural network type.

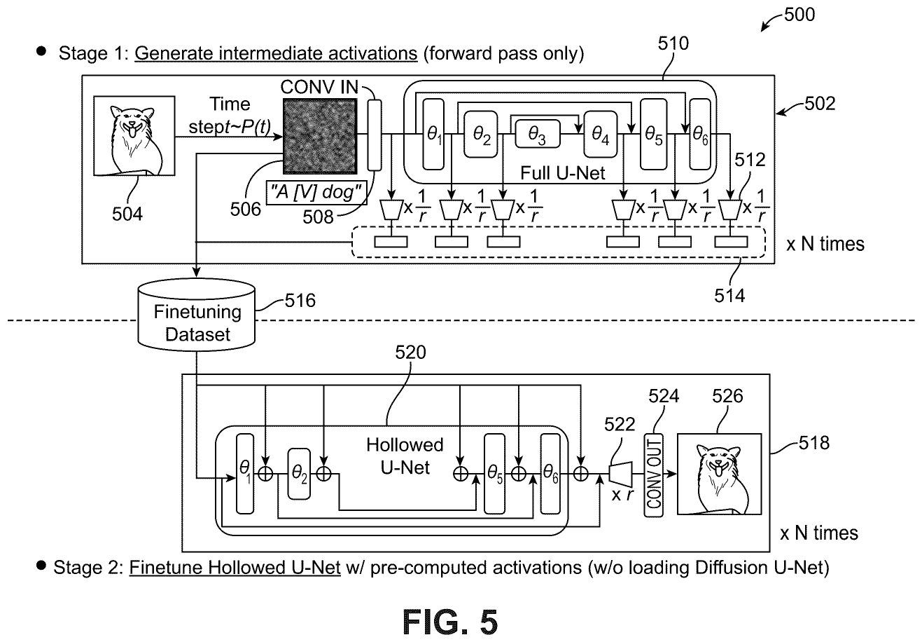

FIG. 5 is a diagram illustrating a two-stage training (or finetuning) process 500. The two-stage training process 500 can reduce the amount of memory needed when training a neural network, in accordance with some aspects of this disclosure. While the two-stage process 500 is described with respect to the U-Net architecture, the process can be performed for any type of neural network. A first stage 502 of the two-stage process 500 includes loading a full neural network 510 (e.g., full U-Net) into a processor (e.g., a GPU, DSP, NPU, NSP, or other processor) and performing a forward pass of the full neural network 510 to generate intermediate activations 512. As described herein, the forward pass includes processing user-specific data by the neural network layers of the full neural network 510. A second stage 518 includes loading a hollowed neural network 520 (e.g., a hollowed U-Net) into the processor (e.g., GPU, NPU, etc.) and performing a forward pass of the hollowed neural network 520 to process the intermediate activations 512 and a backward pass to update parameters the hollowed neural network 520 (e.g., using an input personal image 504 as ground truth). The full network 510 and the hollowed neural network 520 can be separately loaded/stored in the processor to achieve reduced memory usage. By serially performing processing on these different neural networks, reduced memory requirements can be achieved.

As shown in FIG. 5, the first stage 502 includes processing a noise input 506 (as an example of user-specific data) during the forward pass of the full neural network 510 to generate intermediate activations 512. In some aspects, during a particular time step, the noise input 506 can be provided as input to a first convolutional layer 508. The first convolutional layer 508 can generate an output by applying convolutional filters (e.g., kernel) to the noise input 506. The output of the first convolutional layer 508 can be provided to the full neural network 510.

The full neural network 510 can process the output during a forward pass to generate the intermediate activations 512. The intermediate activations 512 (e.g., projection layers) are generated using the neural network layers ϕ 1-ϕ 6 in the full neural network 510. In some cases, there may be multiple forward passes generating N sets of intermediate activations 514. The N sets of intermediate activations 514 can be stored in memory as a finetuning dataset 516. In some cases, the memory can be local store (e.g., on-device) or can be external storage (not stored on the device). For instance, if there are one hundred training steps, then the forward pass can be repeated one hundred times and one hundred sets of the intermediate activations 512 can be generated. The sets of the intermediate activations 514 can be used to finetune the hollowed neural network 520. When forward pass only is used for finetuning in the first stage 502, optimization states do not need to be stored, as optimization states are used for backpropagation to update parameters of the network.

The second stage 518 includes finetuning the hollowed neural network 520. In some cases, during the second stage 518, only the hollowed neural network 520 is loaded into the processor (e.g., GPU, NPU, NSP, DSP, or other processor). In some examples, a data loader (not shown) can obtain one set of data or a set of data for each step of processing in the first stage 502. In some cases, the sets of intermediate activations 514 from the finetuning dataset 516 can be loaded into the processor one set at a time for processing by the hollowed neural network 520. The hollowed neural network 520 is built or generated by including a subset of the neural network layers that are in the full neural network 510. For example, as shown, the full neural network 510 has neural network layers ϕ 1-ϕ 6, while the hollowed neural network 520 includes the first neural network layer ϕ 1, the second neural network layer ϕ 2, the fifth neural network layer ϕ 5, and the sixth neural network layer ϕ 6. In some cases, the hollowed neural network 520 has fewer parameters in neural network layers that are shared with the full neural network 510. For example, one or more of the first neural network layer ϕ 1, the second neural network layer ϕ 2, the fifth neural network layer ϕ 5, and the sixth neural network layer ϕ 6 of the hollowed neural network 520 may have fewer parameters than the corresponding first neural network layer ϕ 1, second neural network layer ϕ 2, fifth neural network layer ϕ 5, and sixth neural network layer ϕ 6 of the full neural network 510.

Each set of intermediate activations from the sets of intermediate activations 514 can be processed by the first neural network layer ϕ 1, second neural network layer ϕ 2, fifth neural network layer ϕ 5, and sixth neural network layer ϕ 6 of the hollowed neural network 520 to generate an output of the hollowed neural network 520. An output projection layer 522 can process the output from the hollowed neural network 520 and provides the output to a convolutional layer 524. The convolutional layer 524 can process the projection layer 522 output to generate the output image 526. The output image 526 can be compared to the input personal image 504 to determine a loss (e.g., based on a training loss, such as L1 loss, L2 loss, CE loss, etc.). In some cases, instead of the input personal image 504, the input can be text. In such cases, the text input can be processed by a tokenizer (not shown) and a text encoder (not shown) can be used to generate the set of tensors 506 based on tokens output by the tokenizer.

In some aspects, the first stage 502 and the second stage 518 can be run on a mobile device, such as a user device 104. In such an example, the full neural network 510 can be loaded onto a processor (e.g., GPU, etc.) of the device to generate the intermediate activations. In the second stage 518, the hollowed neural network 520 is separately loaded into the user device 104 and finetuned using the precomputed intermediate activations. In some cases, the finetuned hollowed neural network 520 can be available for inference on the user device 104. In some aspects, the parameters of the finetuned hollowed neural network 520 can be transferred or projected to the full neural network 510. In such aspects, the full neural network 510 can be used on the device 104 for inference.

The finetuning of the hollowed neural network 520 using the precomputed activations uses less memory relative to finetuning the full neural network 510. For instance, as described previously, the hollowed neural network 520 has fewer neural network layers than the full neural network 510 and in some cases has fewer parameters in neural network layers that are shared with the full neural network 510. The missing neural network layers in the hollowed neural network 520 (relative to the full neural network 510 that also includes neural network layers ϕ 3 and ϕ 4) is complemented by saving precomputed intermediate activations 512 from the full neural network 510 and using the intermediate activations 512 for finetuning the hollowed neural network 520.

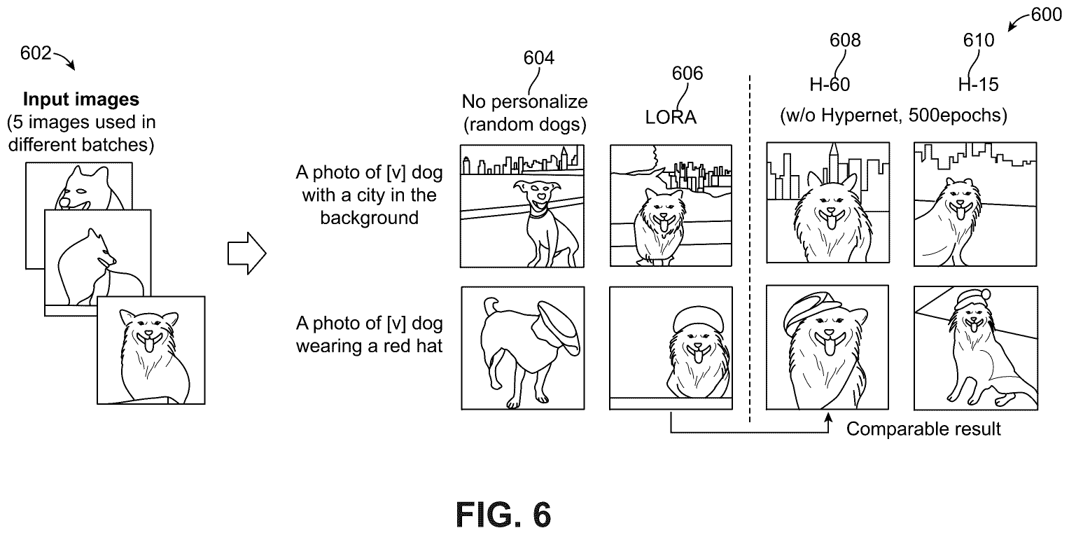

FIG. 6 is a diagram illustrating various results of memory reduction 600, in accordance with some aspects of this disclosure. A set of input images 602 was used in a comparison study to determine how much memory reduction can be achieved compared to LoRA. In some examples, a hollowed neural network had 40% of the layers removed. The number of model parameters was reduced from 857 million to 521 million. In another example, 85% of the layers were removed from the full net which resulted in 134 million model parameters. With respect to memory usage, in the study, memory used by a known finetuning approach called “DreamBooth”, which is a finetuning text-to-image diffusion model for subject-driven generation was 16.53 GB. The LoRA approach used 7.53 GB. With 40% of the layers removed, the inventors achieved the use of 5.64 GB of memory or a 25.1% memory reduction. With 85% of the layers removed, the memory usage was 3.87 GB, thus achieving a 48.6% memory reduction.

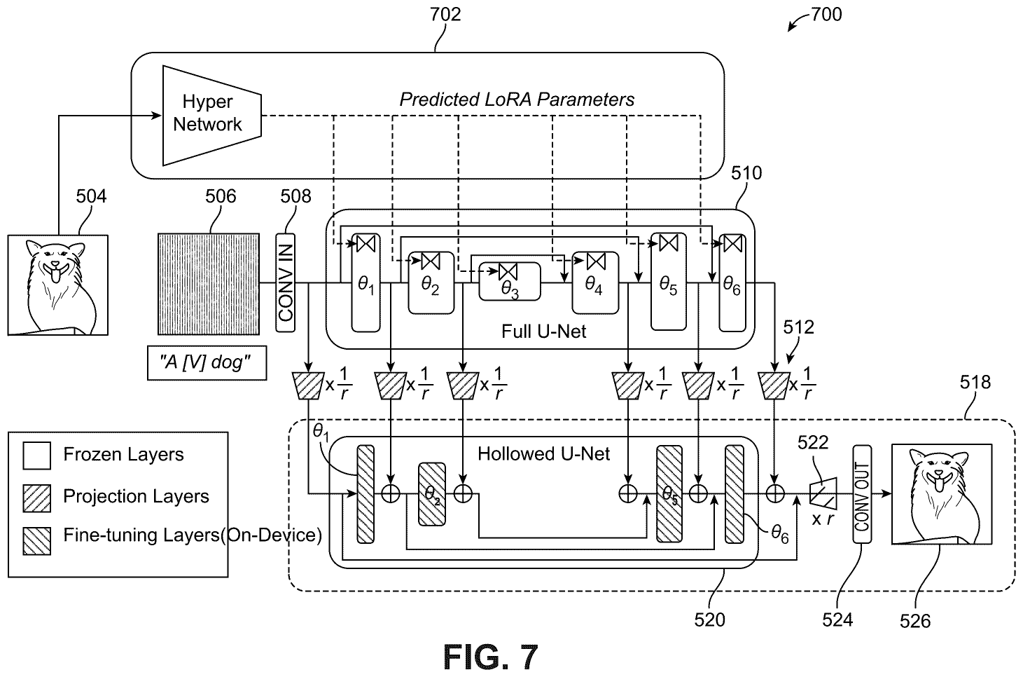

In the study, a request was made to a generative model for a photo of a dog with a city in the background and a second request photo of a dog wearing a red hat. The set of input images 602 can be, for example, five images of the same dog. A first set of results 604 did not include any personalization finetuning of the model. A random dog is shown in the resulting images. A second set of results 606 illustrates the output of the two queries for the LoRA process. A third set of results 608 illustrates the disclosed hollow net approach with 60% of the layers removed, and without the use of a hyper network (see FIG. 7 and description for the use of a hyper network as a pretrained initialization module) and five hundred epochs or complete passes through the entire training dataset. A fourth set of results 610 represent the output when 15% of the layers were removed and without the use of the hyper network and five hundred epochs or complete passes through the entire training dataset. The LoRA approach typically requires about one thousand epochs.

FIG. 7 is a diagram illustrating the use of a hyper network when finetuning a neural network 700, in accordance with some aspects of this disclosure. As illustrated in FIG. 7, the use of pretrained initialization models and how the finetuning approach can be compatible with such use. Introducing a pretrained initialization module can improve the process by reducing the number of finetuning steps in connection with the use of the hollowed neural network 520.

In the example neural network 700 of FIG. 7, the use of a pretrained initialization module is added as compared to the process 500 of FIG. 5. The pretrained initialization module is, in some examples, a hyper network 702 that receives the input personal image 504 and that generates rank-1 LoRA parameters for fast personalization of the model from the input personal image 504. Other pretrained initialization modules can be used in some cases to reduce the number of finetuning steps. A hyper network is a network that generates weights for a main network (e.g., the full neural network 510). The full U-Net learns to map a raw input to their desired targets. For example, the hyper network 702 can process a set of inputs (e.g., inference data) that contain information about the structure of the weights and can generates the weight for that layer. The predicted LoRA parameters are fed to each of the neural network layers ϕ 1-ϕ 6 of the full neural network 510, resulting in updated or initialized layers ϕ 1-ϕ 6.

As shown in FIG. 7, in the various stages of finetuning disclosed herein, various layers are frozen such as the layers ϕ 1-ϕ 6 of the full neural network 510. There is a memory usage bottleneck in the context of on-device learning.

Projection layers, intermediate embeddings or intermediate activations 512 are shown being provided to the hollowed neural network 520. The finetuning layers are shown as layers ϕ 1-2 and ϕ 5-6 of the hollowed neural network 520 with output projection layer 522 and a convolutional output layer or second convolutional layer 524 that generates the output image 526. The disclosed approach is inherently compatible and orthogonal with different efficient/zero-shot personalization methods (e.g., BLIP-Diffusion and IP-Adapter), and different synergies were identified with different initialization modules. BLIP-Diffusion is a pre-trained subject representation for controllable text-to-image generation and editing. IP-Adapter or image prompt adapter is a text-compatible image prompt adapter for text-to-image diffusion models. An initialization of the full neural network 510 can occur and then the approach can include updating or finetuning an initialized full-U-Net which can be performed at a network node.

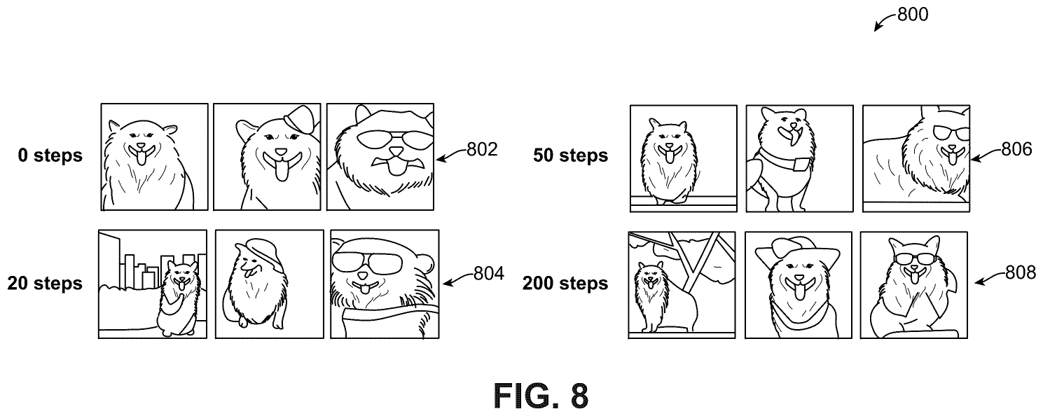

FIG. 8 is a diagram illustrating results of experiments with varying numbers of finetuning steps 800, in accordance with some aspects of this disclosure. The various images shown illustrate experimental results when using a side-tuning algorithm when suboptimal rank-1 LoRA is provided as initialization as shown in FIG. 7. A first series of images 802 relate to using LoRA as a pretrained initialization with zero finetuning steps. A second series of images 804 show the experimental results with twenty steps of finetuning. A third series of images 806 show the experimental results with fifty steps of finetuning. A fourth series of images 808 show the experimental results with two-hundred steps of finetuning. As more steps are used, one can see that the images get closer to matching the look of the dog in the input personal image 504. In general, one can reduce the required number of finetuning steps to fifty to two-hundred finetuning steps when using pretrained initialization. Without initialization, the side-tuning process typically requires five hundred to one thousand steps.

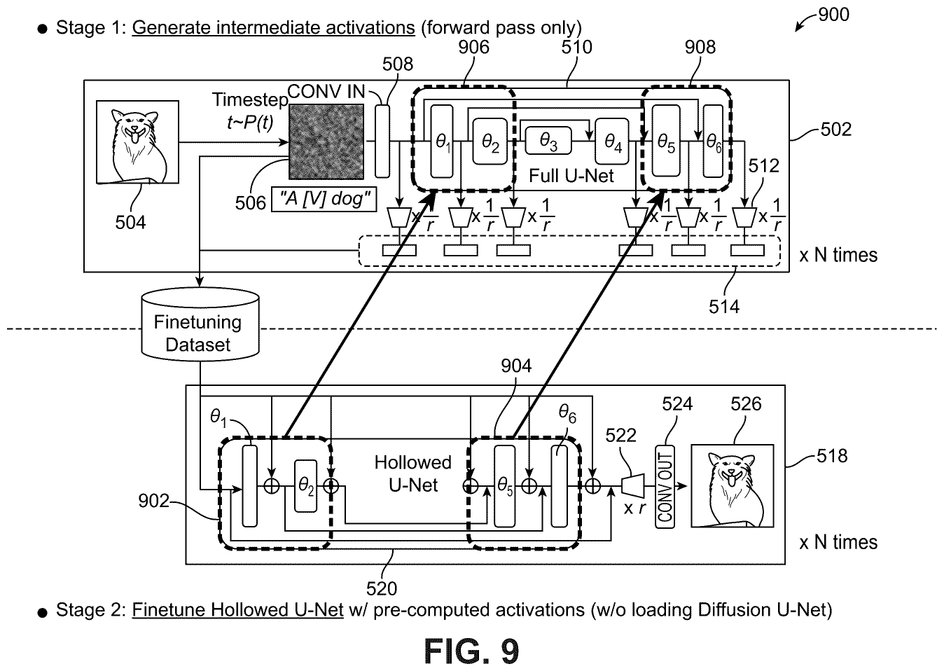

FIG. 9 is a diagram illustrating how to merge personalized knowledge from a hollowed neural network into a full neural network 900, in accordance with some aspects of this disclosure. In order to make inference more efficient, one can merge personalized knowledge from the hollowed neural network 520 into the full neural network 510. The concepts disclosed in FIG. 9 relate to merging personalized knowledge from the hollowed neural network 520 after finetuning is complete. For example, after training the model on a user's image of a dog, the user may then provide a user input such as “Show me an image of my dog on the grass.” To make the process more efficient, a first set of hollowed U-Net layers 902 and a second set of hollowed U-Net layers 904 can be trained using LoRA training on the personalized data rather than directly updating layers of the hollowed neural network 520. Then, the approach can include transferring the weights or knowledge of the personalized LoRA from the hollowed neural network 520 into the full neural network 510 to a first set of full U-Net layers 906 and a second set of full U-Net layers 908 respectively as shown in FIG. 9. In one aspect, then during inference, one uses only the full neural network 510 with updated parameters from the corresponding layers from the hollowed neural network 520 as trained via a LoRA training process.

According to some aspects, the systems and techniques described herein can provides on-device LoRA personalization and can enable personalized image generation, document generation, and/or other uses. The concept of the hollowed neural network 520 can be applied to LLMs as well as other machine-learning models and is not limited to images.

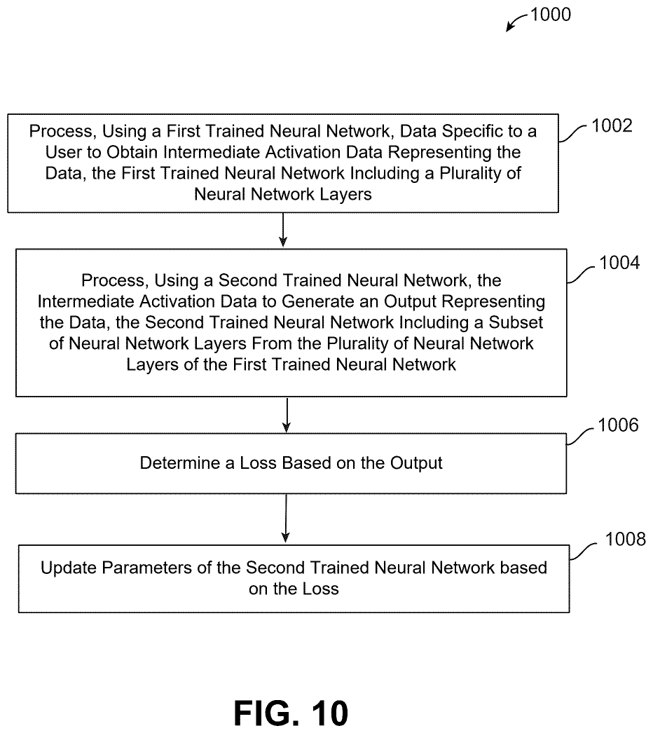

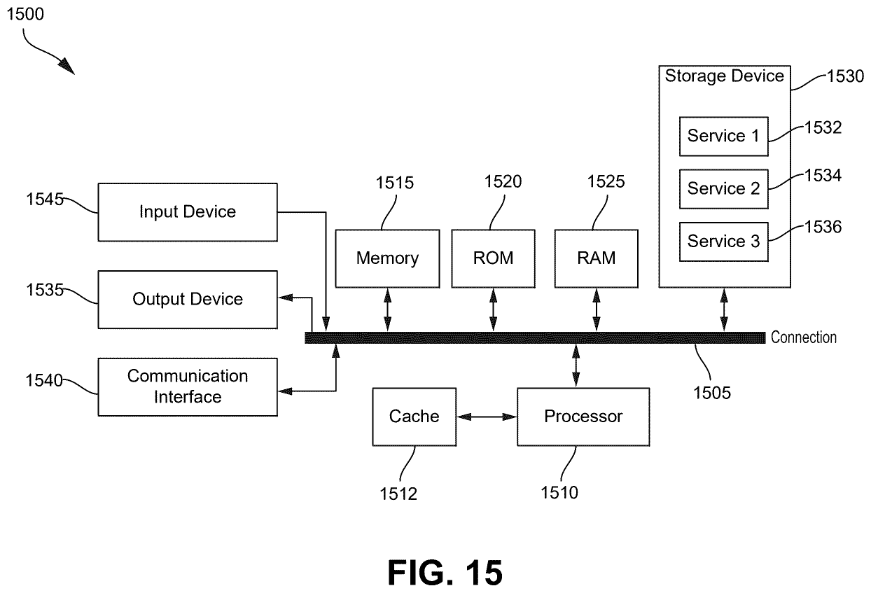

FIG. 10 illustrates an example process 1000 for side-tuning a hollowed neural network, according to some aspects of this disclosure. The process 1000 can be used for reducing memory usage when finetuning a neural network. The process 1000 can be performed by a computing device or system (e.g., computing system 1500 of FIG. 15 or any subcomponent thereof implementing one or more of the full neural network 510 of FIG. 5, the hollowed neural network 520 of FIG. 5, and/or other network, system, or component described herein) or by a component or system (e.g., a chipset, one or more processors such as one or more central processing units (CPUs), graphics processing units (GPUs), neural signal processors (NSPs), neural processing units (NPUs), digital signal processors (DSPs), any combination thereof, and/or other type of processor(s), or other component or system) of the computing device. The operations of the process 1000 may be implemented as software components that are executed and run on one or more processors (e.g., processor 1510 of FIG. 15 or other processor(s)). Further, the transmission and reception of signals by the computing device in the process 1000 may be enabled, for example, by one or more antennas and/or one or more transceivers (e.g., wireless transceiver(s)). At block 1002, the computing device (or component thereof) can process, using a first trained neural network (e.g., the full neural network 510 of FIG. 5, a neural network having the U-Net architecture 1400 of FIG. 14, etc.), data specific to a user to obtain intermediate activation data representing the data, the first trained neural network including a plurality of neural network layers. In some aspects, the first trained neural network can be a diffusion neural network. In some aspects, the data specific to the user can include an item of media content (e.g., an image, a video, etc.) and a text input associated with the item of media content (e.g., a text prompt, such as that described with respect to FIG. 1). In some aspects, the text input can include a text prompt to generate the image of the particular object. Any input modality or combination of modalities can be used to provide the input.

At block 1004, the computing device (or component thereof) can process, using a second trained neural network (e.g., the hollowed neural network 520 of FIG. 5, etc.), the intermediate activation data to generate an output representing the data. The output can include an image of a particular object, a text document, or other output (e.g., as shown in FIG. 1). The second trained neural network includes a subset of neural network layers from the plurality of neural network layers of the first trained neural network. In some aspects, the second trained neural network can be generated based on removing at least one neural network layer from the plurality of neural network layers of the first trained neural network. For example, as described herein, the hollowed neural network 520 of FIG. 5 can be generated or built by removing certain layers of the full neural network 510. In some aspects, the at least one neural network layer can be removed based on a task. In some examples, the task can include an image generation task in which the computing device can generate new images given a new text prompt (e.g., as shown in FIG. 1). In some cases, the new images may be personalized (e.g., based on the text prompt). In some examples, the task may be a generalized task. In some aspects, the second trained neural network can be generated further based on removing a plurality of parameters from the subset of neural network layers.

In some aspects, the computing device (or component thereof) can load the first trained neural network into a memory to process the data, where the second trained neural network is not loaded into the memory when processing the data by a processor. In some cases, the processor can include a GPU, an NPU, an NSP, a DSP, or other type of signal processor. In some aspects, the computing device (or component thereof) can load the second trained neural network into the memory to process the intermediate activation data, determine the loss, and update the parameters of the second trained neural network, where the first trained neural network is not loaded into the memory when processing the intermediate activation data, determining the loss, and updating the parameters of the second trained neural network by the processor.

At block 1006, the computing device (or component thereof) can determine a loss based on the output. For instance, the loss can include a training loss, such as an L1 loss, an L2 loss, a cross-entropy (CE) loss, and/or other type of loss.

At block 1008, the computing device (or component thereof) can update parameters of the second trained neural network based on the loss. In some aspects, the computing device (or component thereof) can transfer updated parameters of the second trained neural network to the first trained neural network to generate a finetuned first neural network (e.g., a personalized first neural network). For instance, after the training of the second trained neural network, the computing device (or component thereof) can project the updated parameters (e.g., personalized information of the second trained neural network, such as LoRA parameters) back into layers of the first trained neural network to generate the finetuned first neural network.

In some aspects, the computing device (or component thereof) can maintain, based on a particular use case (e.g., based on a use case parameter), one or both of the finetuned first neural network and/or the second trained neural network in the memory. In some examples, the use case parameter can include a memory requirement for an inference task, can be associated with a determination of whether the inference task is a personalized task or a general task, and/or other parameter. For instance, in some aspects, the updated parameters can be projected back to the first trained neural network in use cases where limited memory for performing inference using the first trained neural network (e.g., the stage of generating new images given new text prompts) is required. In such aspects, if the updated parameters (e.g., personalized LoRA parameters) of the second trained neural network are projected back to the first trained neural network, both the first and second trained neural networks do not need to be maintained in memory for inference. Such projection of the updated parameters back to the first trained neural network may not be required in all cases, such as depending on the particular use case. For instance, the first and second trained neural networks can be maintained for general and personalized representations, respectively.

The computing device (or component thereof) can perform inference on input data using the finetuned first neural network (e.g., by processing the input data to generate a personalized output, such as that described with respect to FIG. 1) and/or in some cases using the second trained neural network (e.g., with the updated parameters). In some aspects, the input data can include a text prompt, an image, and/or other input data. For instance, the computing device (or component thereof) can obtain the input data based on user input from the user, where the input data includes a text prompt to generate an image comprising a particular object.

In some aspects, a non-transitory computer-readable medium can have stored thereon instructions which, when executed by one or more processors, cause the one or more processors to perform operations according to any of operations in block 1002 through block 1008. In another example, an apparatus can include one or more means for performing operations according to any of operations shown in block 1002 through block 1008.

The components of the computing device of process 1000 can be implemented in circuitry. For example, the components can include and/or can be implemented using electronic circuits or other electronic hardware, which can include one or more programmable electronic circuits (e.g., microprocessors, graphics processing units (GPUs), central processing units (CPUs), neural processing units (NPUs), neural signal processors (NSPs), digital signal processors (DSPs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 1000 is illustrated as a logical flow diagram, the operations of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation. Any number of the described operations can be combined in any order and/or in parallel to implement the processes.

Additionally, process 1000 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

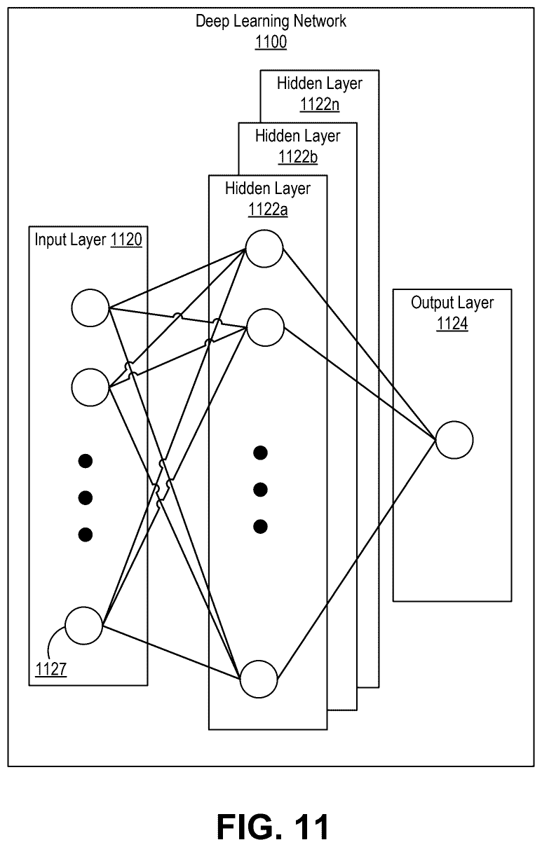

As described above, one or more of the machine learning systems or models described herein may be implemented using a neural network or multiple neural networks. FIG. 11 is an illustrative example of a deep learning neural network or neural network 1100 that can be used by the neural network 1100 of FIG. 11. An input layer 1120 includes input data. In one illustrative example, the input layer 1120 can include data representing the pixels of an input video frame. The neural network 1100 includes multiple hidden layers 1122a, 1122b, through 1122n. The hidden layers 1122a, 1122b, through 1122n include “n” number of hidden layers, where “n” is an integer greater than or equal to one. The number of hidden layers can be made to include as many layers as needed for the given application. The neural network 1100 further includes an output layer 1124 that provides an output resulting from the processing performed by the hidden layers 1122a, 1122b, through 1122n. In one illustrative example, the output layer 1124 can provide a classification for an object in an input video frame. The classification can include a class identifying the type of object (e.g., a person, a dog, a cat, or other object).

The neural network 1100 is a multi-layer neural network of interconnected nodes. Each node can represent a piece of information. Information associated with the nodes is shared among the different layers and each layer retains information as information is processed. In some cases, the neural network 1100 can include a feed-forward network, in which case there are no feedback connections where outputs of the network are fed back into itself. In some cases, the neural network 1100 can include a recurrent neural network, which can have loops that allow information to be carried across nodes while reading in input.

Information can be exchanged between nodes through node-to-node interconnections between the various layers. Nodes of the input layer 1120 can activate a set of nodes in the first hidden layer 1122a. For example, as shown, each of the input nodes of the input layer 1120 is connected to each of the nodes of the first hidden layer 1122a. The nodes of the hidden layers 1122a, 1122b, through 1122n can transform the information of each input node by applying activation functions to the information. The information derived from the transformation can then be passed to and can activate the nodes of the next hidden layer 1122b, which can perform their own designated functions. Example functions include convolutional, up-sampling, data transformation, and/or any other suitable functions. The output of the hidden layer 1122b can then activate nodes of the next hidden layer, and so on. The output of the last hidden layer 1122n can activate one or more nodes of the output layer 1124, at which an output is provided. In some cases, while nodes (e.g., node 1127) in the neural network 1100 are shown as having multiple output lines, a node has a single output and all lines shown as being output from a node represent the same output value.

In some cases, each node or interconnection between nodes can have a weight that is a set of parameters derived from the training of the neural network 1100. Once the neural network 1100 is trained, the neural network 1100 can be referred to as a trained neural network. The trained neural network can be used to classify one or more objects. For example, an interconnection between nodes can represent a piece of information learned about the interconnected nodes. The interconnection can have a tunable numeric weight that can be tuned (e.g., based on a training dataset), allowing the neural network 1100 to be adaptive to inputs and able to learn as more and more data is processed.

The neural network 1100 is pre-trained to process the features from the data in the input layer 1120 using the different hidden layers 1122a, 1122b, through 1122n in order to provide the output through the output layer 1124. In an example in which the neural network 1100 is used to identify objects in images, the neural network 1100 can be trained using training data that includes both images and labels. For instance, training images can be input into the network, with each training image having a label indicating the classes of the one or more objects in each image (basically, indicating to the network what the objects are and what features they have). In one illustrative example, a training image can include an image of a number 2, in which case the label for the image can be [0 0 1 0 0 0 0 0 0 0].

In some cases, the neural network 1100 can adjust the weights of the nodes using a training process called backpropagation. Backpropagation can include a forward pass, a loss function, a backward pass, and a weight update. The forward pass, loss function, backward pass, and parameter update is performed for one training iteration. The process can be repeated for a certain number of iterations for each set of training images until the neural network 1100 is trained well enough so that the weights of the layers are accurately tuned.

For the example of identifying objects in images, the forward pass can include passing a training image through the neural network 1100. The weights are initially randomized before the neural network 1100 is trained. The image can include, for example, an array of numbers representing the pixels of the image. Each number in the array can include a value from 0 to 255 describing the pixel intensity at that position in the array. In some examples, the array can include a 28×28×3 array of numbers with 28 rows and 28 columns of pixels and 3 color components (such as red, green, and blue, or luma and two chroma components, or the like).

For a first training iteration for the neural network 1100, the output will likely include values that do not give preference to any particular output value due to the weights being randomly selected at initialization. For example, if the output is a vector with probabilities that the object includes different classes, the probability value for each of the different classes may be equal or at least very similar (e.g., for ten possible classes, each class may have a probability value of 0.1). With the initial weights, the neural network 1100 is unable to determine low level features and thus cannot make an accurate determination of what the classification of the object might be. A loss function can be used to analyze error in the output. Any suitable loss function definition can be used. An example of a loss function includes a mean squared error (MSE). The MSE is defined as

$${E}_{total} = \sum \frac{1}{2} {( target - output )}^{2} ,$$

which calculates the sum of one-half times a ground truth output (e.g., the actual answer) minus the predicted output (e.g., the predicted answer) squared. The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. The neural network 1100 can perform a backward pass by determining which inputs (weights) most contributed to the loss of the network, and can adjust the weights so that the loss decreases and is eventually minimized.

A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as

$$w = {w}_{i} - η \frac{dL}{dW} ,$$

where w denotes a weight, wᵢ denotes the initial weight, and η denotes a learning rate. The learning rate can be set to any suitable value, with a high learning rate including larger weight updates and a lower value indicating smaller weight updates. In some cases, the neural network 1100 can be trained using self-supervised learning.

The neural network 1100 can include any suitable deep network. An example includes a convolutional neural network (CNN), which includes an input layer and an output layer, with multiple hidden layers between the input and out layers. An example of a CNN is described below with respect to FIG. 11. The hidden layers of a CNN include a series of convolutional, nonlinear, pooling (for downsampling), and fully connected layers. The neural network 1100 can include any other deep network other than a CNN, such as an autoencoder, a deep belief nets (DBNs), a Recurrent Neural Networks (RNNs), among others.

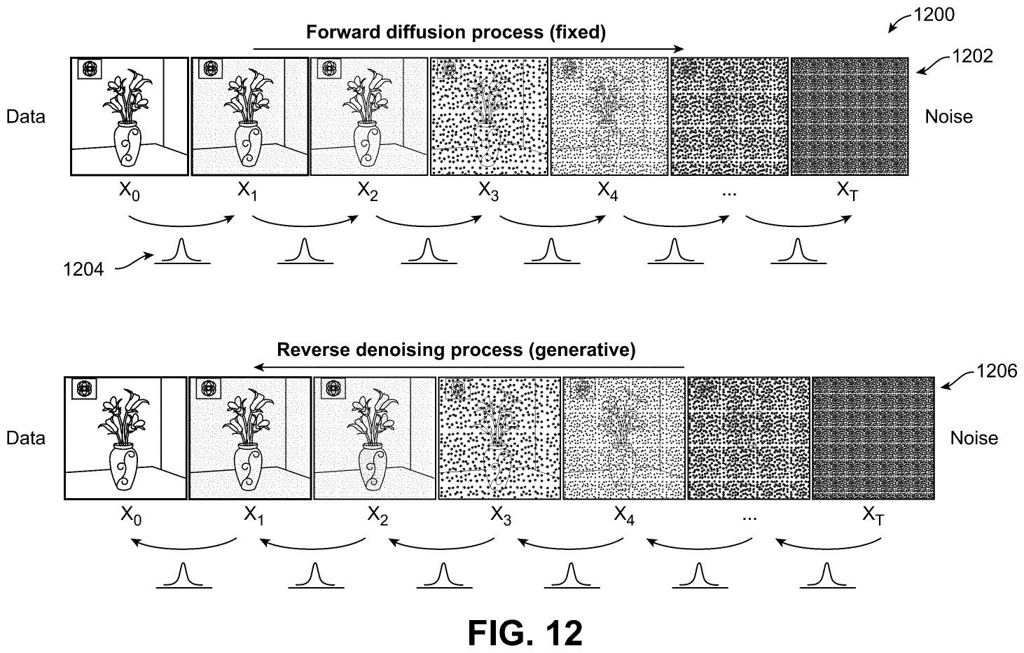

In some cases, the machine-learning systems (e.g., neural networks) described herein may include a diffusion neural network model. FIG. 12 provides two sets of images 1200 that show the forward diffusion process (which is fixed) and the reverse diffusion process (which is learned) of a diffusion model. As shown in the forward diffusion process of FIG. 12, noise 1203 is gradually added to a first set of images 1202 at different time steps for a total of T time steps (e.g., making up a Markov chain), producing a sequence of noisy samples X₁ through X_{T}.

Diffusion models from a training perspective will take an image and will slowly add noise to the image to destroy the information in the image. In some aspects, the noise 1203 is Gaussian noise. Each time step can correspond to each consecutive image of the first set of images 1202 shown in FIG. 12. The initial image X₀ of FIG. 12 is of a vase. Addition of the noise 1203 to each image (corresponding to noisy samples X₁ to X_{T}) results in gradual diffusion of the pixels in each image until the final image (corresponding to sample X_{T}) essentially matches the noise distribution. For example, by adding the noise, each data sample X₁ through X_{T} gradually loses its distinguishable features as the time step becomes larger, eventually resulting in the final sample X_{T} being equivalent to the target noise distribution, for instance a unit variance zero-Gaussian [symbol] (0,1).

The second set of images 1204 shows the reverse diffusion process in which X_{T} is the starting point with a noisy image (e.g., one that has Gaussian noise). The diffusion model can be trained to reverse the diffusion process (e.g., by training a model p_{θ}(xₜ₋₁|xₜ)) to generate new data. In some aspects, a diffusion model can be trained by finding the reverse Markov transitions that maximize the likelihood of the training data. By traversing backwards along the chain of time steps, the diffusion model can generate the new data. For example, as shown in FIG. 12, the reverse diffusion process proceeds to generate X₀ as the image of the vase. In other cases, the input data and output data can vary based on the task for which the diffusion model is trained.

As noted above, the diffusion model is trained to be able to denoise or recover the original image X₀ in an incremental process as shown in the second set of images 1204. In some aspects, the neural network of the diffusion model can be trained to recover Xₜ given Xₜ₋₁, such as provided in the below example equation:

$$q ( {x}_{t} \vert {x}_{t - 1} ) = 𝒩 ( {x}_{t} ; \sqrt{1 - {β}_{t}} {x}_{t - 1} , {β}_{t} I )$$

A diffusion kernel can be defined as:

$$Define {\hat{∝}}_{t} = {\prod }_{s = 1}^{t} ( 1 - {β}_{s} ) \to q ( {x}_{t} \vert {x}_{0} ) = 𝒩 ( {x}_{t} ; \sqrt{{\hat{∝}}_{t}} {x}_{0} , ( 1 - {\hat{∝}}_{t} ) I )$$

Sampling can be defined as follows:

$${x}_{t} = \sqrt{{\hat{∝}}_{t}} {x}_{0} + \sqrt{1 - {\hat{∝}}_{t}} ε where ε ∼ 𝒩 ( 0 , I ) .$$

In some cases, the βₜ values schedule (also referred to as a noise schedule) is designed such that \hat{∝}_{T}→0 and q(x_{T}|x₀)≈ [symbol] (x_{T}; 0,1).

The diffusion model runs in an iterative manner to incrementally generate the input image X₀. In some examples, the model may have twenty steps. However, in other examples, the number of steps can vary.

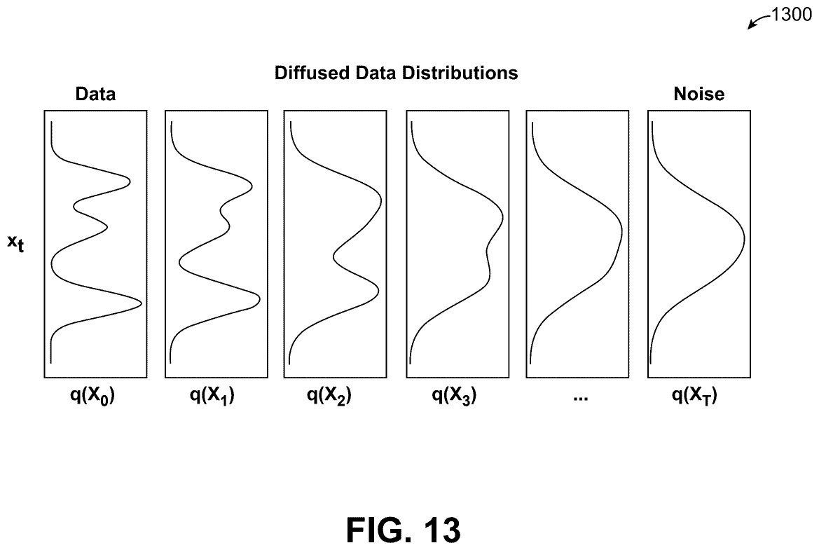

FIG. 13 is a diagram 1300 illustrating how diffusion data is distributed from initial data to noise using a diffusion model in the forward diffusion direction, in accordance with some aspects. Note that the initial data q(X₀) is detailed in the initial stage of the diffusion process. An illustrative example of the data q(X₀) is the initial image of the vase shown in FIG. 12. As the diffusion model iterates and iteratively adds sampled noise to the data from t=0 to t=T, as shown in FIG. 13, the data becomes nosier and may ultimately result in pure noise (e.g., at q(X_{T})). The example of FIG. 13 illustrates the progression of the data and how the data becomes diffused with noise in the forward diffusion process.

In some aspects, the diffused data distribution (e.g., as shown in FIG. 13) can be as follows:

$$q ( {x}_{t} ) = \int q ( {x}_{0} , {x}_{t} ) {dx}_{0} = \int q ( {x}_{0} ) q ( {x}_{t} \vert {x}_{0} ) {dx}_{0} .$$

In the above equation, q(xₜ) represents the diffused data distribution, q(x₀,xₜ) represents the joint distribution, q(x₀) represents the input data distribution, and q(xₜ|x₀) is the diffusion kernel. In this regard, the model can sample xₜ˜q(xₜ) by first sampling x₀˜q(x₀) and then sampling xₜ˜q(xₜ|x₀) (which may be referred to as ancestral sampling). The diffusion kernel takes the input and returns a vector or other data structure as output.

The following is a summary of a training algorithm and a sampling algorithm for a diffusion model. A training algorithm can include the following steps:

1: repeat
2: x₀ ~ q(x₀)
3: t ~ Uniform ({1,..., T })
4: ϵ ~ [symbol] (0, I)
5: Take gradient descent step on
∇_{ø} || ϵ − ϵ_{ø} ( \sqrt{ [symbol]+ x₀} + \sqrt{1 −} ϵ, t) ||²
6: until converged

A sampling algorithm can include the following steps:

1: x_{T} ~ [symbol] (0, I)
2: for t = T, ... , 1 do
3: z ~ [symbol] (0, I)
$4 \text{:} {x}_{t - 1} = \frac{1}{\sqrt{{\hat{∝}}_{t}}} ( {x}_{t} - \frac{1 - {\hat{∝}}_{t}}{\sqrt{1 - {\hat{∝}}_{t}}} {∈}_{θ} ( {x}_{t} , t ) ) + {σ}_{t} z$
5: end for
6: return x₀

FIG. 14 is a diagram illustrating a U-Net architecture 1400 for a diffusion model, in accordance with some aspects. The initial image 1402 (e.g., of a vase) is provided to the U-Net architecture 1400 which includes a series of residual networks (ResNet) blocks and self-attention layers to represent the network ε_{⊖}(xₜ, t). The U-Net architecture 1400 also includes fully connected layers 1408. In some cases, time representation 1410 can be sinusoidal positional embeddings or random Fourier features. Noisy output 1406 from the forward diffusion process is also shown.

The U-Net architecture 1400 includes a contracting path 1404 and an expansive path 1405 as shown in FIG. 14, which gives the network the U-shaped architecture. The contracting path 1404 can be a convolutional network that includes repeated convolutional layers (that apply convolutional operations), each followed by a rectified linear unit (ReLU) and a max pooling operation. When images are being processed (e.g., the image 1402) during the contracting path 1404, the spatial information of the image 1402 is reduced as features are generated. The expansive path 1405 combines the features and spatial information through a sequence of up-convolutions and concatenations with high-resolution features from the contracting path 1404. Some of the layers can be self-attention layers, which leverage global interactions between semantic features at the end of the encoder to explicitly model full contextual information.

FIG. 15 is a diagram illustrating an example of a system for implementing certain aspects of the present disclosure. In particular, FIG. 15 illustrates an example of computing system 1500, which can be for example any computing device making up a computing system, a camera system, or any component thereof in which the components of the system are in communication with each other using connection 1505. Connection 1505 can be a physical connection using a bus, or a direct connection into processor 1510, such as in a chipset architecture. Connection 1505 can also be a virtual connection, networked connection, or logical connection.

In some examples, computing system 1500 is a distributed system in which the functions described in this disclosure can be distributed within a datacenter, multiple data centers, a peer network, etc. In some examples, one or more of the described system components represents many such components each performing some or all of the function for which the component is described. In some examples, the components can be physical or virtual devices.

Example computing system 1500 includes at least one processing unit (CPU or processor 1510) and connection 1505 that couples various system components including system memory or memory 1515, such as read-only memory (ROM 1520) and random access memory (RAM 1525) to processor 1510. Computing system 1500 can include a cache 1512 of high-speed memory connected directly with, in close proximity to, or integrated as part of processor 1510.

Processor 1510 can include any general purpose processor and a hardware service or software service, such as services 1532, 1534, and 1536 stored in storage device 1530, configured to control processor 1510 as well as a special-purpose processor where software instructions are incorporated into the actual processor design. Processor 1510 may essentially be a completely self-contained computing system, containing multiple cores or processors, a bus, memory controller, cache, etc. A multi-core processor may be symmetric or asymmetric.

To enable user interaction, computing system 1500 includes an input device 1545, which can represent any number of input mechanisms, such as a microphone for speech, a touch-sensitive screen for gesture or graphical input, keyboard, mouse, motion input, speech, etc. Computing system 1500 can also include output device 1535, which can be one or more of a number of output mechanisms. In some instances, multimodal systems can enable a user to provide multiple types of input/output to communicate with computing system 1500. Computing system 1500 can include communications interface 1540, which can generally govern and manage the user input and system output.

The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1540 may also include one or more Global Navigation Satellite System (GNSS) receivers or transceivers that are used to determine a location of the computing system 1500 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1530 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L#), resistive random-access memory (RRAM/ReRAM), phase change memory (PCM), spin transfer torque RAM (STT-RAM), another memory chip or cartridge, and/or a combination thereof.

The storage device 1530 can include software services, servers, services, etc., that when the code that defines such software is executed by the processor 1510, it causes the system to perform a function. In some examples, a hardware service that performs a particular function can include the software component stored in a computer-readable medium in connection with the necessary hardware components, such as processor 1510, connection 1505, output device 1535, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include one or more memories, one or more processors, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the examples disclosed herein may be implemented as electronic hardware, computer software, firmware, or combinations thereof. To clearly illustrate the interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, then the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the present disclosure include:

Aspect 1. An apparatus for finetuning one or more neural networks, the apparatus comprising: a memory; and a processor coupled to the memory and configured to: process, using a first trained neural network, data specific to a user to obtain intermediate activation data representing the data, the first trained neural network comprising a plurality of neural network layers; process, using a second trained neural network, the intermediate activation data to generate an output representing the data, the second trained neural network comprising a subset of neural network layers from the plurality of neural network layers of the first trained neural network; determine a loss based on the output; and update parameters of the second trained neural network based on the loss.

Aspect 2. The apparatus of Aspect 1, wherein the second trained neural network is generated based on removing at least one neural network layer from the plurality of neural network layers of the first trained neural network.

Aspect 3. The apparatus of Aspect 2, wherein the second trained neural network is generated further based on removing a plurality of parameters from the subset of neural network layers.

Aspect 4. The apparatus of any of Aspects 2 or 3, wherein the at least one neural network layer is removed based on a task.

Aspect 5. The apparatus of Aspect 4, wherein the task comprises an image generation task.

Aspect 6. The apparatus of any of Aspects 1-5, wherein the processor is configured to: load the first trained neural network into the processor to process the data, wherein the second trained neural network is not loaded into the processor when processing the data; and load the second trained neural network into the processor to process the intermediate activation data, determine the loss, and update the parameters of the second trained neural network, wherein the first trained neural network is not loaded into the processor when processing the intermediate activation data, determining the loss, and updating the parameters of the second trained neural network.

Aspect 7. The apparatus of any of Aspects 1-6, wherein the first trained neural network comprises a diffusion neural network.

Aspect 8. The apparatus of any of Aspects 1-7, wherein the processor comprises a graphics processing unit, a neural processing unit, a neural signal processor, or a digital signal processor.

Aspect 9. The apparatus of any of Aspects 1-8, wherein the data specific to the user comprises an item of media content and a text input associated with the item of media content.

Aspect 10. The apparatus of Aspect 9, wherein the output comprises an image of a particular object, and wherein the text input comprises a text prompt to generate the image of the particular object.

Aspect 11. The apparatus of any of Aspects 1-10, wherein the processor is configured to: transfer updated parameters of the second trained neural network to the first trained neural network to generate a finetuned first neural network; and perform inference on input data using the finetuned first neural network.

Aspect 12. The apparatus of Aspect 11, wherein the processor is configured to obtain the input data based on user input from the user, the input data comprising a text prompt to generate an image comprising a particular object.

Aspect 13. The apparatus of any of Aspects 11 or 12, wherein the processor is configured to: maintain, based on a use case parameter, at least one of the finetuned first neural network or the second trained neural network in the memory.

Aspect 14. The apparatus of Aspect 13, wherein the use case parameter comprises at least one of a memory requirement for an inference task or a parameter associated with the inference task is a personalized task or a general task.

Aspect 15. The apparatus of any of Aspects 1-14, wherein the parameters of the second trained neural network that are updated comprise updated parameters and wherein the processor is configured to: project the updated parameters back into layers of the first trained neural network to generate a personalized first trained neural network.

Aspect 16. A method for finetuning one or more neural networks, the method comprising: processing, using a first trained neural network, data specific to a user to obtain intermediate activation data representing the data, the first trained neural network comprising a plurality of neural network layers; processing, using a second trained neural network, the intermediate activation data to generate an output representing the data, the second trained neural network comprising a subset of neural network layers from the plurality of neural network layers of the first trained neural network; determining a loss based on the output; and updating parameters of the second trained neural network based on the loss.

Aspect 17. The method of Aspect 16, wherein the second trained neural network is generated based on removing at least one neural network layer from the plurality of neural network layers of the first trained neural network.

Aspect 18. The method of Aspect 17, wherein the second trained neural network is generated further based on removing a plurality of parameters from the subset of neural network layers.

Aspect 19. The method of any of Aspects 17 or 18, wherein the at least one neural network layer is removed based on a task.

Aspect 20. The method of Aspect 18, wherein the task comprises an image generation task.

Aspect 21. The method of any of Aspects 16-20, further comprising: loading the first trained neural network into a memory to process the data, wherein the second trained neural network is not loaded into the memory when processing the data by a processor; and loading the second trained neural network into the memory to process the intermediate activation data, determine the loss, and update the parameters of the second trained neural network, wherein the first trained neural network is not loaded into the memory when processing the intermediate activation data, determining the loss, and updating the parameters of the second trained neural network.

Aspect 22. The method of any of Aspects 16-21, wherein the first trained neural network comprises a diffusion neural network.

Aspect 23. The method of any of Aspects 16-22, wherein the processor comprises a graphics processing unit, a neural processing unit, a neural signal processor, or a digital signal processor.

Aspect 24. The method of any of Aspects 16-23, wherein the data specific to the user comprises an item of media content and a text input associated with the item of media content.

Aspect 25. The method of Aspect 24, wherein the output comprises an image of a particular object, and wherein the text input comprises a text prompt to generate the image of the particular object.

Aspect 26. The method of any of Aspects 16-25, further comprising: transferring updated parameters of the second trained neural network to the first trained neural network to generate a finetuned first neural network; and performing inference on input data using the finetuned first neural network.

Aspect 27. The method of Aspect 26, further comprising: obtaining the input data based on user input from the user, the input data comprising a text prompt to generate an image comprising a particular object.

Aspect 28. The method of any of Aspects 26 or 27, further comprising: maintaining, based on a use case parameter, at least one of the finetuned first neural network or the second trained neural network in a memory.

Aspect 29. The method of Aspect 28, wherein the use case parameter comprises a memory requirement for an inference task or is associated with a determination of whether the inference task is a personalized task or a general task.

Aspect 30. The method of any of Aspects 16-29, wherein the parameters of the second trained neural network that are updated comprise updated parameters and wherein the method further comprises: projecting the updated parameters back into layers of the first trained neural network to generate a personalized first trained neural network.

Aspect 31. A computer-readable storage medium storing instructions which, when executed by at least one processor coupled to the computer-readable storage medium cause the at least one processor to perform operations according to any of Aspects 16-30.

Aspect 32. An apparatus for finetuning one or more neural networks), the apparatus comprising means for performing operations according to any of Aspects 16-30.

What is claimed is:

1. An apparatus for finetuning one or more neural networks, the apparatus comprising:
a memory; and
a processor coupled to the memory and configured to:
process, using a first trained neural network, data specific to a user to obtain intermediate activation data representing the data, the first trained neural network comprising a plurality of neural network layers;
process, using a second trained neural network, the intermediate activation data to generate an output representing the data, the second trained neural network comprising a subset of neural network layers from the plurality of neural network layers of the first trained neural network;
determine a loss based on the output; and
update parameters of the second trained neural network based on the loss.

2. The apparatus of claim 1, wherein the second trained neural network is generated based on removing at least one neural network layer from the plurality of neural network layers of the first trained neural network.

3. The apparatus of claim 2, wherein the second trained neural network is generated further based on removing a plurality of parameters from the subset of neural network layers.

4. The apparatus of claim 2, wherein the at least one neural network layer is removed based on a task.

5. The apparatus of claim 4, wherein the task comprises an image generation task.

6. The apparatus of claim 1, wherein the processor is configured to:
load the first trained neural network into the processor to process the data, wherein the second trained neural network is not loaded into the processor when processing the data; and
load the second trained neural network into the processor to process the intermediate activation data, determine the loss, and update the parameters of the second trained neural network, wherein the first trained neural network is not loaded into the processor when processing the intermediate activation data, determining the loss, and updating the parameters of the second trained neural network.

7. The apparatus of claim 1, wherein the first trained neural network comprises a diffusion neural network.

8. The apparatus of claim 1, wherein the processor comprises a graphics processing unit, a neural processing unit, a neural signal processor, or a digital signal processor.

9. The apparatus of claim 1, wherein the data specific to the user comprises an item of media content and a text input associated with the item of media content.

10. The apparatus of claim 9, wherein the output comprises an image of a particular object, and wherein the text input comprises a text prompt to generate the image of the particular object.

11. The apparatus of claim 1, wherein the processor is configured to:
transfer updated parameters of the second trained neural network to the first trained neural network to generate a finetuned first neural network; and
perform inference on input data using the finetuned first neural network.

12. The apparatus of claim 11, wherein the processor is configured to obtain the input data based on user input from the user, the input data comprising a text prompt to generate an image comprising a particular object.

13. The apparatus of claim 11, wherein the processor is configured to:
maintain, based on a use case parameter, at least one of the finetuned first neural network or the second trained neural network in the memory.

14. The apparatus of claim 13, wherein the use case parameter comprises at least one of a memory requirement for an inference task or a parameter associated with the inference task being a personalized task or a general task.

15. A method for finetuning one or more neural networks, the method comprising:
processing, using a first trained neural network, data specific to a user to obtain intermediate activation data representing the data, the first trained neural network comprising a plurality of neural network layers;
processing, using a second trained neural network, the intermediate activation data to generate an output representing the data, the second trained neural network comprising a subset of neural network layers from the plurality of neural network layers of the first trained neural network;
determining a loss based on the output; and
updating parameters of the second trained neural network based on the loss.

16. The method of claim 15, wherein the second trained neural network is generated based on removing at least one neural network layer from the plurality of neural network layers of the first trained neural network.

17. The method of claim 15, further comprising:
loading the first trained neural network into a memory to process the data, wherein the second trained neural network is not loaded into the memory when processing the data by a processor; and
loading the second trained neural network into the memory to process the intermediate activation data, determine the loss, and update the parameters of the second trained neural network, wherein the first trained neural network is not loaded into the memory when processing the intermediate activation data, determining the loss, and updating the parameters of the second trained neural network.

18. The method of claim 15, further comprising:
transferring updated parameters of the second trained neural network to the first trained neural network to generate a finetuned first neural network; and
performing inference on input data using the finetuned first neural network.

19. The method of claim 18, further comprising obtaining the input data based on user input from the user, the input data comprising a text prompt to generate an image comprising a particular object.

20. A computer-readable storage medium storing instructions which, when executed by at least one processor coupled to the computer-readable storage medium cause the at least one processor to be configured to:
process, using a first trained neural network, data specific to a user to obtain intermediate activation data representing the data, the first trained neural network comprising a plurality of neural network layers;
process, using a second trained neural network, the intermediate activation data to generate an output representing the data, the second trained neural network comprising a subset of neural network layers from the plurality of neural network layers of the first trained neural network;
determine a loss based on the output; and
update parameters of the second trained neural network based on the loss.
